(19) United States
(12) Patent Application Publication
(10) Pub. No.: US 2019/0196429 A1
(43) Pub. Date: Jun. 27, 2019

(54) EQUIPMENT CONTROL PROCESSING METHOD AND DEVICE

(71) Applicant: Beijing Chuangyu Technology Co., Ltd., Beijing (CN)

(72) Inventors: Pan Han, Beijing (CN); Ang Zhao, Beijing (CN)

(21) Appl. No.: 16/051,299

(22) Filed: Jul. 31, 2018

(30) Foreign Application Priority Data
Dec. 25, 2017 (CN) 201711421087.X

(51) Int. Cl. G05B 19/045; G05B 19/418

(52) U.S. Cl. CPC G05B 19/045; G05B 19/41835; G05B 2219/23289; G05B 2219/45027; G05B 2219/45031; G05B 19/4187

(57) ABSTRACT

The embodiments of the present disclosure provide an equipment control processing method and device. The method includes: determining an action type according to an action of the component to be controlled; determining a target action logic code class according to the action type and a plurality of pre-created action logic code classes, wherein the action logic code class is created according to the action types extracted from the actions of a plurality of the components to be controlled; creating an action object corresponding to the component to be controlled according to the target action logic code class; correlating control signal corresponding to the action of the component to be controlled and the action object corresponding to the component to be controlled, and storing correlation between the control signal and the action object, so as to implement control processing on the component to be controlled according to the correlation between the control signal and the action object. The device is used to perform the method above. The method and device provided by the embodiments of the present disclosure improve the equipment control efficiency.

CROSS-REFERENCE TO RELATED APPLICATIONS AND CLAIM OF PRIORITY

This application claims priority to Chinese Application No. 201711421087.X, filed Dec. 25, 2017, the entire contents of which are fully incorporated herein by reference in its entirety.

### TECHNICAL FIELD

The embodiments of the present disclosure relate to the technical field of computers, and particularly to an equipment control processing method and device.

### BACKGROUND

With the rapid development of computer technology, equipment control through computer technology has been widely popularized, and researches on the control efficiency thereof have received more and more attention.

Under the current technology conditions, most of the existing equipment control methods write program codes for relevant functions of the controlled components. For example, the vacuum valve in MOCVD (Metal-organic Chemical Vapor Deposition) equipment has two actions: open and close. The existing control methods will write relevant component codes for this type of valve. For example, the vacuum valve class (VacValveClass) provides operations of open and close. It is capable of creating objects for this type of valve with defined vacuum valve class. Vacuum valve objects such as valve1, valve2, valve3 can be created with the vacuum valve class, and the created vacuum valve objects valve1, valve2, valve3 belong to the same type of component, and the operations (open and close) are the same. However, since the previously defined class is vacuum valve without providing operation functions for components other than vacuum valve, the original code class cannot be used to control new parts, therefore new component classes must be created when it is necessary to perform open and close operations on another type of component. For example, as for the control of a power controller, although the same control operations open and close are performed, the power controller and vacuum valve do not belong to the same component class. Therefore it needs to rewrite code class for the power controller when performing open and close operations to the power controller. In this way, the workload of writing program codes is increased, the maintenance of the software code becomes more complicated and the possibility of errors is raised, which greatly affects the equipment control efficiency.

Therefore, it is sought to propose a method to improve the equipment control efficiency in the industry.

### SUMMARY

The embodiments of the present disclosure provide an equipment control processing method and device.

In one respect, the embodiments of the present disclosure provide an equipment control processing method, including:
determining an action type of a component to be controlled according to an action of the component to be controlled;
determining a target action logic code class corresponding to the component to be controlled, according to the action type and a plurality of pre-created action logic code classes; wherein the action logic code class is created according to the action types extracted from the actions of a plurality of the components to be controlled;
creating an action object corresponding to the component to be controlled according to the target action logic code class;
correlating control signal corresponding to the action of the component to be controlled and the action object corresponding to the component to be controlled, and storing correlation between the control signal and the action object, so as to implement control processing on the component to be controlled according to the correlation between the control signal and the action object.

In another respect, the embodiments of the present disclosure provide an equipment control processing device, comprising at least one processor; at least one memory; a first processing unit, a second processing unit, a first creating unit and a correlating unit stored in the memory, when being executed by the processor,
the first processing unit is configured to determine an action type of a component to be controlled according to an action of the component to be controlled;
the second processing unit is configured to determine a target action logic code class corresponding to the component to be controlled, according to the action type and a plurality of pre-created action logic code classes; wherein the action logic code class is created according to the action types extracted from the actions of a plurality of the components to be controlled;
the first creating unit is configured to create an action object corresponding to the component to be controlled according to the target action logic code class; and
the correlating unit is configured to correlate control signal corresponding to the action of the component to be controlled and the action object corresponding to the component to be controlled, and store correlation between the control signal and the action object, so as to implement control processing on the component to be controlled according to the correlation between the control signal and the action object.

In another respect, the embodiments of the present disclosure provide an electronic device, comprising a processor, a memory and a bus, wherein,
the processor and the memory communicate with each other through the bus; and
the processor can call computer programs in the memory to execute steps of the methods above.

In another respect, the embodiments of the present disclosure further provide a computer readable storage medium, in which computer programs are stored, wherein steps of the methods above are implemented when a processor executes the programs.

The equipment control processing method and device provided by the embodiments of the present disclosure improve the equipment control efficiency by determining the target action logic code class according to the action type determined by the action of the component to be controlled, and a plurality of pre-created action logic code classes, and creating the action object corresponding to the component to be controlled according to the target action logic code class, and correlating the control signal corresponding to the action of the component to be controlled and the action object corresponding to the component to be controlled, and storing the correlation between the control signal and the action object, so as to implement control processing on the component to be controlled according to the correlation between the control signal and the action object.

### BRIEF DESCRIPTION OF THE DRAWINGS

In order to more clearly describe the embodiments of the present disclosure or the technical solutions in the prior art, the drawings to be used in describing the embodiments or the prior art will be briefly described below, obviously, the drawings in the following description are some embodiments of the present disclosure, for those of ordinary skill in the art, other drawings may also be obtained based on these drawings without any creative work.

FIG. 1 is a flow chart of the equipment control processing method provided by an embodiment of the present disclosure;

FIG. 2 is a schematic diagram of the control logic provided by an embodiment of the present disclosure;

FIG. 3 is a schematic diagram of the control logic provided by an embodiment of the present disclosure;

FIG. 4 is a schematic diagram of the control logic provided by an embodiment of the present disclosure;

FIG. 5 is a schematic diagram of the control logic provided by an embodiment of the present disclosure;

FIG. 6 is a block diagram of the equipment control processing device provided by an embodiment of the present disclosure;

FIG. 7 is a block diagram of the equipment control processing device provided by an embodiment of the present disclosure;

FIG. 8 is a block diagram of the equipment control processing device provided by an embodiment of the present disclosure;

FIG. 9 is a block diagram of an entity of the electronic device of an embodiment of the present disclosure.

### DETAILED DESCRIPTION

In order to make the objectives, technical solutions, and advantages of the embodiments of the present disclosure clearer, the technical solutions of the embodiments of the present disclosure will be described clearly with reference to the accompanying drawings hereinafter. Obviously, the described embodiments are merely some but not all of the embodiments of the present disclosure. On the basis of the embodiments of the present disclosure, all other embodiments obtained by the person of ordinary skill in the art without creative work shall fall within the protection scope of the present disclosure.

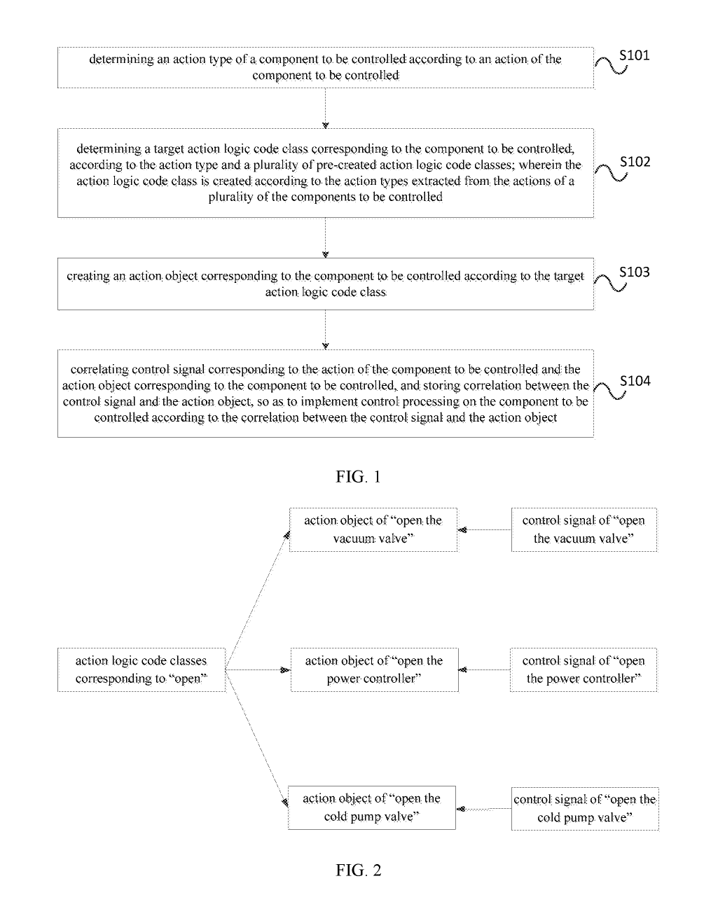

FIG. 1 is a flow chart of the equipment control processing method provided by an embodiment of the present disclosure. As shown in FIG. 1, the present embodiment provides an equipment control processing method, comprising:

S101. determining an action type of a component to be controlled according to an action of the component to be controlled.

Specifically, the equipment control processing device determines the action type of the component to be controlled according to the action of the component to be controlled. The action type is extracted from actions of a plurality of the components to be controlled, and may include “open”, “close”, “switch”, and may also include other action types. The specific action types may be set and adjusted according to actual conditions, which is not specifically defined herein. The action of the component to be controlled may be one or multiple, and each action corresponds to an action type; the component to be controlled may be a valve, a power controller, a cold pump valve, etc. It may also be other components to be controlled, and may be adjusted according to actual conditions; for example, the component to be controlled may be a vacuum valve, and the actions thereof may include opening and closing a vacuum valve, the corresponding action types are “open” and “close”.

S102. determining a target action logic code class corresponding to the component to be controlled, according to the action type and a plurality of pre-created action logic code classes; wherein the action logic code class is created according to the action types extracted from the actions of a plurality of the components to be controlled.

Specifically, the device matches the action type of the component to be controlled with the action types corresponding to the plurality of pre-created action logic code classes, and determines the action logic code class of the action type that is the same with the action type of the component to be controlled, as the target action logic code class of the component to be controlled; wherein the action logic code class is created according to the action types extracted from the actions of a plurality of the components to be controlled, each action type corresponding to an action logic code class. Taking the action type “open” of a vacuum valve as an example, the device determines the action logic code class corresponding to the action type “open” (Switch Logic Class-Open (Open Signal=1, Close Signal=0) as the target action logic code class of the vacuum valve.

S103. creating an action object corresponding to the component to be controlled according to the target action logic code class.

Specifically, the device creates the action object corresponding to the component to be controlled according to the target action logic code class. For example, the component to be controlled is a vacuum valve, the actions thereof include “open the vacuum valve”, the corresponding action type is “open”, the device determines the action logic code class corresponding to the action type “open” (Switch Logic Class-Open (Open Signal=1, Close Signal=0) as the target action logic code class of the vacuum valve, and creates the action object “open the vacuum valve” (Vacuum valve open object) according to the target action logic code.

S104. correlating control signal corresponding to the action of the component to be controlled and the action object corresponding to the component to be controlled, and storing correlation between the control signal and the action object, so as to implement control processing on the component to be controlled according to the correlation between the control signal and the action object.

Specifically, the device correlates the control signal corresponding to the action of the component to be controlled and the action object corresponding to the component to be controlled, and stores the correlation between the control signal and the action object, that is, implanting the control signal corresponding to the action of the component to be controlled into the action object corresponding to the component to be controlled, so that the device determines and performs the action object correlated with the received control signal according to the received control signal and the correlation between the control signal and the action object after receiving the control signal, so as to implement corresponding control processing on the component to be controlled corresponding to the action object.

The equipment control processing method provided by the embodiments of the present disclosure improves the equipment control efficiency by determining the target action logic code class according to the action type determined by the action of the component to be controlled and a plurality of pre-created action logic code classes, and creating the action object corresponding to the component to be controlled according to the target action logic code class, and correlating the control signal corresponding to the action of the component to be controlled and the action object corresponding to the component to be controlled, and storing the correlation between the control signal and the action object, so as to implement control processing on the component to be controlled according to the correlation between the control signal and the action object. In addition, compared with encoding control logic for the component class in the prior art, the equipment control processing method provided by the embodiments of the present disclosure significantly reduces the workload of software encoding by clustering a plurality of actions into action type and determining the action logic code class for the action type. When a new component to be controlled is need to be added, it would be enough to determine the target action logic code class according to the action control logic of the component to be controlled and create the corresponding action object without re-encoding the component to be controlled, which greatly enhances the flexibility of software expansion, avoids the impact of directly modifying the code on the original system, improves the system stability, and reduces the maintenance cost of the software system.

On the basis of the embodiments above, the method further includes:
receiving the control signal;
determining a target action object corresponding to the received control signal according to the received control signal and the correlation between the control signal and the action object; and
executing the target action object so that the component to be controlled corresponding to the target action object is controlled accordingly.

Specifically, the device receives the control signal, searches the correlation between the control signal and the action object according to the received control signal, and determines the action object correlated with the received control signal as the target action object, then executes the target action object. The control signal may be input by the user through the operating terminal corresponding to the component to be controlled, or may be sent by the user by pressing the corresponding control button of the component to be controlled, and may also be sent through other methods. The specific method may be adjusted according to actual situation, which is not specifically limited herein. It should be noted that, when the target action object is executed according to the action logic code class corresponding to the target action object, the value of the implanted control signal is set according to the specific received control signal so as to control the component to be controlled.

For example, the components to be controlled are respectively a vacuum valve, a power controller and a cold pump valve, the corresponding action types thereof all include “open” and “close”. Taking action type “open” as an example, as shown in FIG. 2, the action of the vacuum valve is “open the vacuum valve”, the action of the power controller is “open the power controller”, and the action of the cold pump valve is “open the cold pump valve”, the target action logic code classes corresponding to the vacuum valve, the power controller, and the cold pump valve are the action logic code class corresponding to “open” (Switch Logic Class-Open (Open Signal=1, Close Signal=0)). The device creates an “open the vacuum valve” action object (Vacuum valve open object), an “open the power controller” action object (Heater open object), and an “open the cold pump valve” action object (Gate valve open object) respectively according to the target action logic code class; and respectively correlates the control signal of opening the vacuum valve with the “open the vacuum valve” action object (Vacuum valve open object), correlates the control signal of opening the power controller with the “open the power controller” action object (Heater open object), and correlates the control signal of opening the cold vacuum valve with the “open the cold pump valve” action object (Gate valve open object); and respectively stores the correlations above.

Taking the vacuum valve as an example, after receiving the control signal of opening the vacuum valve, the device searches the correlation between the control signal and the action object according to the control signal of opening the vacuum vale, and determines the “open the vacuum valve” action object (Vacuum valve open object) corresponding to the control signal of opening the vacuum valve as the target action object, and sets the value of Open Signal in in the action logic code class of the “open the vacuum valve” action object as 1 according to control signal of opening the vacuum valve, sets the value of Close Signal as 0, then executes the “open the vacuum valve” action object (Vacuum valve open object), so as to control the opening of the vacuum valve. The process of controlling the openings of the power controller and the cold pump valve is similar to that of controlling the opening of the vacuum valve above, which will not be described herein.

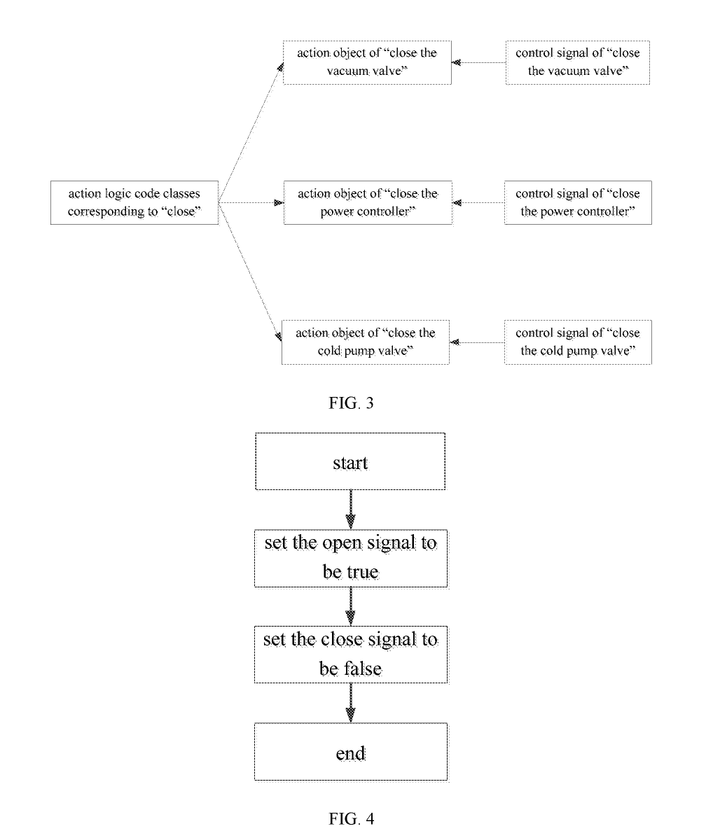

Further, taking the action type “close” as an example, as shown in FIG. 3, the action of the vacuum valve is “close the vacuum valve”, the action of the power controller is “close the power controller”, and the action of the cold pump valve is “close the cold pump valve”, the target action logic code classes corresponding to the vacuum valve, the power controller, and the cold pump valve are the action logic code class corresponding to “close” (Switch Logic Class-Close (Open Signal=0, Close Signal=1)); the device creates a “close the vacuum valve” action object (Vacuum valve close object), a “close the power controller” action object (Heater close object), and a “close the cold pump valve” action object (Gate valve close object) respectively according to the target action logic code class; and respectively correlates the control signal of closing the vacuum valve with the “close the vacuum valve” action object (Vacuum valve close object), correlates the control signal of closing the power controller with the “close the power controller” action object (Heater close object), and correlates the control signal of closing the cold vacuum valve with the “close the cold pump valve” action object (Gate valve close object); and respectively stores the correlations above.

Again taking the vacuum valve as an example, after receiving the control signal of closing the vacuum vale, the device searches the correlation between the control signal and the action object according to the control signal of closing the vacuum vale, and determines the “close the vacuum valve” action object (Vacuum valve close object) corresponding to the control signal of closing the vacuum vale as the target action object, and sets the value of Open Signal in in the action logic code class of the “open the vacuum valve” action object as 0 according to control signal of opening the vacuum valve, sets the value of Close Signal as 1, then executes the “close the vacuum valve” action object (Vacuum valve close object), so as to control the opening of the vacuum valve. The process of controlling the closings of the power controller and the cold pump valve is similar to that of controlling the closing of the vacuum valve above, which will not be described herein.

On the basis of the embodiments above, the method further includes:
extracting a plurality of the action types according to the actions of a plurality of the components to be controlled; and
creating the action logic code class corresponding to each action type respectively.

On the basis of the embodiments above, extracting a plurality of the action types according to the actions of a plurality of the components to be controlled further includes:
determining control logic corresponding to each action according to the actions of the plurality of the components to be controlled; and
determining the actions having a same control logic as one action type.

Specifically, the device analyzes the action logic of the actions of the plurality of components to be controlled according to the actions thereof, and regards the actions that have consistent control logic as one action type, and determines the control logic corresponding to these actions as the control logic corresponding to the action type. Thus the device is able to extract the plurality of the action types according to the actions of the plurality of the components to be controlled, and creates the action logic code class corresponding to each action type respectively according to the control logic corresponding to each action type.

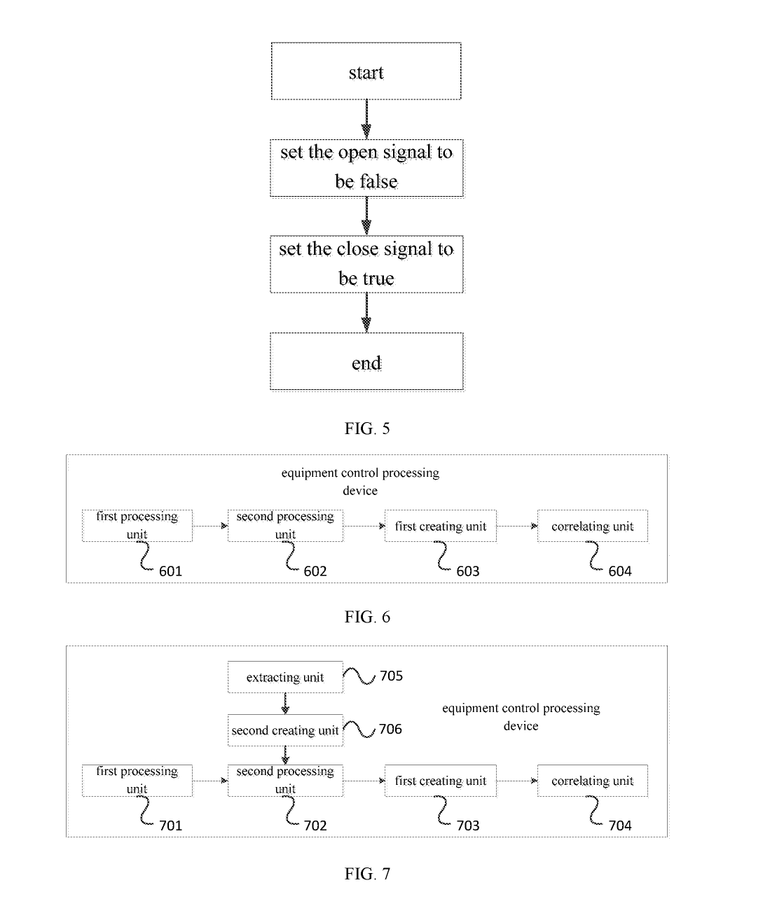

For example, the plurality of the components to be controlled include a vacuum valve, a power controller, and a cold pump valve, the actions of vacuum valve include “open the vacuum valve” and “close the vacuum valve”, the actions of the power controller include “open the power controller” and “close the power controller”, and the actions of the cold pump valve include “open the cold pump valve” and “close the cold pump valve”. As shown in FIG. 4, the control logic of “open the vacuum valve”, “open the power controller” and “open the cold pump valve” is the same, with the open signal to be true and the close signal to be false. Therefore, “open the vacuum valve”, “open the power controller” and “open the cold pump valve” can be categorized as the action type-“open”, and the action logic code class (Switch Logic Class-Open (Open Signal=1, Close Signal=0)) corresponding to the action type-“open” can be created. In addition, as shown in FIG. 5, the control logic of “close the vacuum valve”, “close the power controller” and “close the cold pump valve” are the same, with the open signal to be false and the close signal to be true, therefore, “close the vacuum valve”, “close the power controller” and “close the cold pump valve” can be categorized as the action type-“close”, and the action logic code class (Switch Logic Class-Close (Open Signal=0, Close Signal=1)) corresponding to the action type-“close” can be created.

In each of the embodiments above, the method is applied to the control process of photovoltaic equipment or semiconductor equipment.

Specifically, the equipment control processing method provided by the embodiments of the present disclosure may be applied to the control process of photovoltaic equipment or semiconductor equipment, and may also be applied to the controls and operations of other equipment.

The equipment control processing method provided by the embodiments of the present disclosure improves the equipment control efficiency by determining the target action logic code class according to the action type determined by the action of the component to be controlled, and a plurality of pre-created action logic code classes, and creating the action object corresponding to the component to be controlled according to the target action logic code class, and correlating the control signal corresponding to the action of the component to be controlled and the action object corresponding to the component to be controlled, and storing the correlation between the control signal and the action object, so as to implement control processing on the component to be controlled according to the correlation between the control signal and the action object.

FIG. 6 is a block diagram of the equipment control processing device provided by an embodiment of the present disclosure. As shown in FIG. 6, the embodiment of the present disclosure provides an equipment control processing device, including a first processing unit 601, a second processing unit 602, a first creating unit 603 and a correlating unit 604.

It should be noted that the equipment control processing device also includes at least one processor and at least one memory (not shown in the drawings); the units above which are essentially program modules are stored in the memory, and when being executed by the processor.

The first processing unit 601 is configured to determine an action type of a component to be controlled according to an action of the component to be controlled. The second processing unit 602 is configured to determine a target action logic code class corresponding to the component to be controlled, according to the action type and a plurality of pre-created action logic code classes. The action logic code class is created according to the action types extracted from the actions of a plurality of the components to be controlled. The first creating unit 603 is configured to create an action object corresponding to the component to be controlled according to the target action logic code class The correlating unit 604 is configured to correlate control signal corresponding to the action of the component to be controlled and the action object corresponding to the component to be controlled, and store correlation between the control signal and the action object, so as to implement control processing on the component to be controlled according to the correlation between the control signal and the action object.

Specifically, the first processing unit 601 determines the action type of the component to be controlled according to the action of the component to be controlled, the second processing unit 602 matches the action type of the component to be controlled with the action types corresponding to the plurality of pre-created action logic code classes, and determines the action logic code class of the action type that is the same with the action type of the component to be controlled, as the target action logic code class of the component to be controlled. The action logic code class is created according to the action types extracted from the actions of a plurality of the components to be controlled, each action type corresponding to an action logic code class. The first creating unit 603 creates the action object corresponding to the component to be controlled according to the target action logic code class. The correlating unit 604 correlates the control signal corresponding to the action of the component to be controlled and the action object corresponding to the component to be controlled, and stores the correlation between the control signal and the action object, that is, implanting the control signal corresponding to the action of the component to be controlled into the action object corresponding to the component to be controlled, so that the device determines and performs the action object correlated with the received control signal according to the received control signal and the correlation between the control signal and the action object after receiving the control signal, so as to implement corresponding control processing on the component to be controlled corresponding to the action object. It should be understood that the action type is extracted from actions of a plurality of the components to be controlled, and may include “open”, “close”, “switch”, and may also include other action types. The specific action types may be set and adjusted according to actual conditions, which is not specifically defined herein. The action of the component to be controlled may be one or multiple, and each action corresponds to an action type. The component to be controlled may be a valve, a power controller, a cold pump valve, etc., it may also be other components to be controlled, and may be adjusted according to actual conditions. For example, the component to be controlled may be a vacuum valve, and the actions thereof may include opening and closing a vacuum valve, the corresponding action types are “open” and “close”.

The equipment control processing device provided by the embodiments of the present disclosure improves the equipment control efficiency by determining the target action logic code class according to the action type determined by the action of the component to be controlled, and a plurality of pre-created action logic code classes, and creating the action object corresponding to the component to be controlled according to the target action logic code class, and correlating the control signal corresponding to the action of the component to be controlled and the action object corresponding to the component to be controlled, and storing the correlation between the control signal and the action object, so as to implement control processing on the component to be controlled according to the correlation between the control signal and the action object.

On the basis of the embodiments above, FIG. 7 is a block diagram of the equipment control processing device provided by another embodiment of the present disclosure. As shown in FIG. 7, the equipment control processing device provided by the embodiment of the present disclosure further includes an extracting unit 705 and a second creating unit 706 in addition to the first processing unit 701, the second processing unit 702, the first creating unit 703 and the correlating unit 704, which are consistent with the first processing unit 601, the second processing unit 602, the first creating unit 603 and the correlating unit 604 in the embodiments above.

It should be noted that the equipment control processing device also includes at least one processor and at least one memory (not shown in the drawings); the units above which are essentially program modules are stored in the memory, and when being executed by the processor.

The extracting unit 705 is configured to extract a plurality of the action types according to the actions of the plurality of the components to be controlled; the second creating unit 706 is configured to create the action logic code class corresponding to each action type respectively.

Specifically, the extracting unit 705 determines control logic corresponding to each action according to the actions of the plurality of the components to be controlled, and determines the actions having a same control logic as one action type. Thus the extracting unit 705 is able to extract the plurality of the action types according to the actions of the plurality of the components to be controlled; and the second creating unit 706 is able to create the action logic code class corresponding to each action type respectively according to the control logic corresponding to each action type.

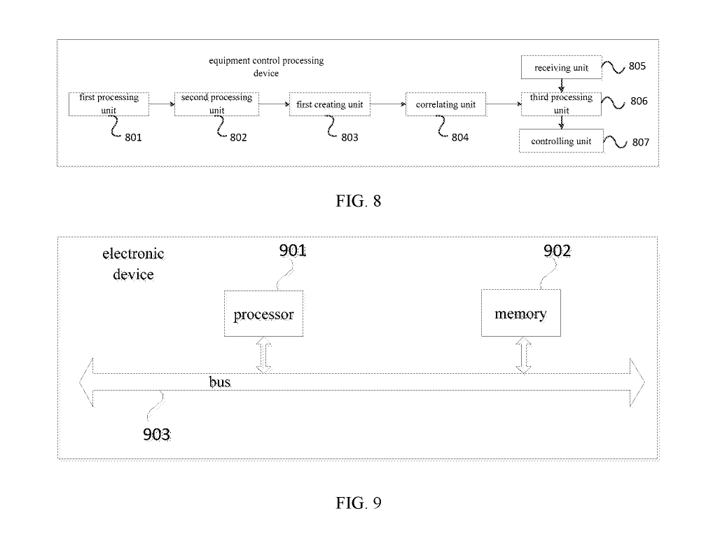

On the basis of the embodiments above, FIG. 8 is a block diagram of the equipment control processing device provided by another embodiment of the present disclosure. As shown in FIG. 8, the equipment control processing device provided by the embodiment of the present disclosure further includes a receiving unit 805 a third processing unit 806 and a controlling unit 807 in addition to the first processing unit 801, the second processing unit 802, the first creating unit 803 and the correlating unit 804, which are consistent with the first processing unit 601, the second processing unit 602, the first creating unit 603 and the correlating unit 604 in the embodiments above.

It should be noted that the equipment control processing device also includes at least one processor and at least one memory (not shown in the drawings); the units above which are essentially program modules are stored in the memory, and when being executed by the processor.

The receiving unit 805 is configured to receive the control signal; the third processing unit 806 is configured to determine a target action object corresponding to the received control signal according to the received control signal and the correlation between the control signal and the action object; and the controlling unit 807 is configured to execute the target action object so that the component to be controlled corresponding to the target action object is controlled accordingly.

Specifically, the receiving unit 805 receives the control signal, the third processing unit 806 searches the correlation between the control signal and the action object according to the received control signal, and determines the action object correlated with the received control signal as the target action object, and the controlling unit 807 executes the target action object. The control signal may be input by the user through the operating terminal corresponding to the component to be controlled, or may be sent by the user by pressing the corresponding control button of the component to be controlled, and may also be sent through other methods, the specific method may be adjusted according to actual situation, which is not specifically limited herein. It should be noted that, when the target action object is executed according to the action logic code class corresponding to the target action object, the value of the implanted control signal is set according to the specific received control signal so as to control the component to be controlled.

The equipment control processing device provided by the embodiments of the present disclosure improves the equipment control efficiency by determining the target action logic code class according to the action type determined by the action of the component to be controlled, and a plurality of pre-created action logic code classes, and creating the action object corresponding to the component to be controlled according to the target action logic code class, and correlating the control signal corresponding to the action of the component to be controlled and the action object corresponding to the component to be controlled, and storing the correlation between the control signal and the action object, so as to implement control processing on the component to be controlled according to the correlation between the control signal and the action object.

The embodiments of the equipment control processing device provided by the present disclosure may be specifically configured to execute the processing flows of each of the method embodiments above, the functions thereof will not be described repeatedly herein, and reference may be made to the detailed description of the method embodiments above.

FIG. 9 is a block diagram of an entity of the electronic device of an embodiment of the present disclosure. As shown in FIG. 9, the electronic device may include a processor 901, a memory 902 and a bus 903, wherein the processor 901 and the memory 902 communicate with each other through the bus 903. The processor 901 can call the computer program in the memory 902 to execute the following method: determining an action type of a component to be controlled according to an action of the component to be controlled; determining a target action logic code class corresponding to the component to be controlled, according to the action type and a plurality of pre-created action logic code classes; wherein the action logic code class is created according to the action types extracted from the actions of a plurality of the components to be controlled; creating an action object corresponding to the component to be controlled according to the target action logic code class; correlating control signal corresponding to the action of the component to be controlled and the action object corresponding to the component to be controlled, and storing correlation between the control signal and the action object, so as to implement control processing on the component to be controlled according to the correlation between the control signal and the action object.

An embodiment of the present disclosure provides a computer program product, including a computer program stored in a non-transient computer readable storage medium, the computer program includes program instructions, and when the program instructions are executed by a computer, the methods provided by each of the method embodiments above can be executed, wherein the methods for example, include: determining an action type of a component to be controlled according to an action of the component to be controlled; determining a target action logic code class corresponding to the component to be controlled, according to the action type and a plurality of pre-created action logic code classes; wherein the action logic code class is created according to the action types extracted from the actions of a plurality of the components to be controlled; creating an action object corresponding to the component to be controlled according to the target action logic code class; correlating control signal corresponding to the action of the component to be controlled and the action object corresponding to the component to be controlled, and storing correlation between the control signal and the action object, so as to implement control processing on the component to be controlled according to the correlation between the control signal and the action object.

An embodiment of the present disclosure provides a non-transient computer readable storage medium storing a computer program, the computer program enables a computer to execute the methods provided by each of the method embodiments above, including, such as: determining an action type of a component to be controlled according to an action of the component to be controlled; determining a target action logic code class corresponding to the component to be controlled, according to the action type and a plurality of pre-created action logic code classes; wherein the action logic code class is created according to the action types extracted from the actions of a plurality of the components to be controlled; creating an action object corresponding to the component to be controlled according to the target action logic code class; correlating control signal corresponding to the action of the component to be controlled and the action object corresponding to the component to be controlled, and storing correlation between the control signal and the action object, so as to implement control processing on the component to be controlled according to the correlation between the control signal and the action object.

In addition, the logic instructions in the memory 903 mentioned above may be implemented in the form of software functional units, and may be stored in a computer-readable storage medium when sold or used as independent products. Based on such understanding, the technical solutions of the present disclosure, or the part thereof contributing to the prior art, or parts thereof can be embodied in the form of a software product stored in a storage medium, the software product includes certain instructions so that a computer device (may be a personal computer, a server, or a network device, etc.) performs all or part of the steps of the methods described in each of the embodiments of the present disclosure. The storage medium described above includes various mediums that can store program codes, such as Flash memory, mobile hard disk, read-only memory (ROM), random access memory (RAM), magnetic disk, or optical disk, etc.

The device embodiments described above are for illustration only, in which the units described as separate parts may or may not be physically separated, and the parts displayed as units may or may not be physical units, that is, they may be located in one place, or may also be distributed to multiple network units. According to actual needs, some or all of the modules may be selected to achieve the objects of the solutions of the embodiments. Those of ordinary skill in the art can understand and implement without creative work.

Through the description of the embodiments above, those skilled in the art can clearly understand that each embodiment can be implemented by means of software with necessary universal hardware platform, and can also, of course, by means of hardware. Based on such understanding, the technical solutions of the present disclosure, or the part thereof contributing to the prior art, or parts thereof can be embodied in the form of a software product stored in a storage medium, such as ROM/RAM, magnetic disk, optical disk, etc., the software product includes certain instructions so that a computer device (may be a personal computer, a server, or a network device, etc.) performs the methods described in each of the embodiments, or some parts of the embodiments.

It should be noted that the embodiments above are only used to illustrate rather than to limit the technical solutions of the present disclosure; although the present disclosure has been described in detail with reference to the foregoing embodiments, those of ordinary skill in the art should understand that they can still modify the technical solutions described in the foregoing embodiments, or equivalently replace some of the technical features therein; and these modifications or replacements do not separate the essence of the corresponding technical solutions from the spirit and scope of the technical solutions of each of the embodiments of the present disclosure.

1. An equipment control processing method, comprising:
determining an action type of a component to be controlled according to an action of the component to be controlled;
determining a target action logic code class corresponding to the component to be controlled, according to the action type and a plurality of pre-created action logic code classes, wherein the action logic code class is created according to the action types extracted from the actions of a plurality of the components to be controlled;
creating an action object corresponding to the component to be controlled according to the target action logic code class;
correlating control signal corresponding to the action of the component to be controlled and the action object corresponding to the component to be controlled, and storing correlation between the control signal and the action object, so as to implement control processing on the component to be controlled according to the correlation between the control signal and the action object.

2. The method of claim 1, further comprising:
receiving the control signal;
determining a target action object corresponding to the received control signal according to the received control signal and the correlation between the control signal and the action object; and
executing the target action object so that the component to be controlled corresponding to the target action object is controlled accordingly.

3. The method of claim 1, further comprising:
extracting a plurality of the action types according to the actions of the plurality of the components to be controlled; and
creating the action logic code class corresponding to each action type respectively.

4. The method of claim 3, wherein extracting the plurality of the action types according to the actions of the plurality of the components to be controlled comprises:
determining control logic corresponding to each action according to the actions of the plurality of the components to be controlled; and
determining the actions having a same control logic as one action type.

5. The method of claim 1, wherein the method is applied to control process of photovoltaic equipment or semiconductor equipment.

6. An equipment control processing device, comprising at least one processor, at least one memory, a first processing unit, a second processing unit, a first creating unit and a correlating unit stored in the memory, when being executed by the processor:
the first processing unit is configured to determine an action type of a component to be controlled according to an action of the component to be controlled;
the second processing unit is configured to determine a target action logic code class corresponding to the component to be controlled, according to the action type and a plurality of pre-created action logic code classes; wherein the action logic code class is created according to the action types extracted from the actions of a plurality of the components to be controlled;
the first creating unit is configured to create an action object corresponding to the component to be controlled according to the target action logic code class; and
the correlating unit is configured to correlate control signal corresponding to the action of the component to be controlled and the action object corresponding to the component to be controlled, and store correlation between the control signal and the action object, so as to implement control processing on the component to be controlled according to the correlation between the control signal and the action object.

7. The device of claim 6, further comprising an extracting unit and a second creating unit stored in the memory, when being executed by the processor,
the extracting unit is configured to extract a plurality of the action types according to the actions of the plurality of the components to be controlled; and
the second creating unit is configured to create the action logic code class corresponding to each action type respectively.

8. The device of claim 6, further comprising a receiving unit, a third processing unit and a controlling unit stored in the memory, when being executed by the processor:
the receiving unit is configured to receive the control signal;
the third processing unit is configured to determine a target action object corresponding to the received control signal according to the received control signal and the correlation between the control signal and the action object; and
the controlling unit is configured to execute the target action object so that the component to be controlled corresponding to the target action object is controlled accordingly.

9. A computer readable storage medium, in which computer programs are stored, wherein steps of the method of claim 1 are implemented when a processor executes the programs.
